(19) United States
(12) Patent Application Publication
(10) Pub. No.: US 2025/0113176 A1
(43) Pub. Date: Apr. 3, 2025

(54) MULTIPLE PROFILE DOWNLOADS FOR USER EQUIPMENT

(71) Applicant: GOOGLE LLC, Mountain View, CA (US)

(72) Inventor: Edison Chen, Taipei (TW)

(21) Appl. No.: 18/479,342

(22) Filed: Oct. 2, 2023

(51) Int. Cl. H04W 8/20

(52) U.S. Cl. CPC H04W 8/20

(57) ABSTRACT

A user equipment (UE) concurrently downloads available subscriber identity module (SIM) profiles. The UE identifies a condition wherein one or more SIM profiles is available for download. The UE first identifies the number of available SIM profiles and, in response to identifying multiple available SIM profiles, concurrently downloads at least two of the SIM profiles to the UE. This enables the UE to more quickly use the available SIM profiles to connect to corresponding networks, thereby improving the user experience with the UE.

### BACKGROUND

A user equipment (UE) is configured to attach to a cellular network within range. To establish a data connection between the UE and an attached cellular network, the UE includes a modem to transmit data to and receive data from the cellular network and a subscriber identity module (SIM) device that stores identification and subscriber information associated with the user equipment. In some cases, it is useful for the UE to support connection to different communication networks, such as networks associated with different network carriers, different communication bands, different network capabilities, different network subscription characteristics, and the like, or any combination thereof. To allow for connection to the different communication networks, a UE can employ SIMs, with each SIM providing the data and functionality for connection to a different network. The data used by the SIM to support connection to a corresponding network is generally referred to as a profile.

Further, in some cases the available profiles for a UE change over time. For example, when a UE enters a new or different country, the networks available for connection may change, and thus the profiles available to the UE to support network connection also change. When the available profiles change, the UE can download any new or different profiles over a corresponding network. However, existing approaches to profile download can result in a poor user experience.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a user equipment (UE) that concurrently downloads available SIM profiles in accordance with some embodiments.

FIG. 2 is a flow diagram of a method of concurrently downloading available SIM profiles at a UE in accordance with some embodiments.

FIG. 3 is a signal flow diagram illustrating an example method of the UE of FIG. 1 concurrently downloading available SIM profiles in accordance with some embodiments.

FIG. 4 is a diagram of a timeline showing an example of a UE concurrently downloading available SIM profiles in accordance with some embodiments.

### DETAILED DESCRIPTION

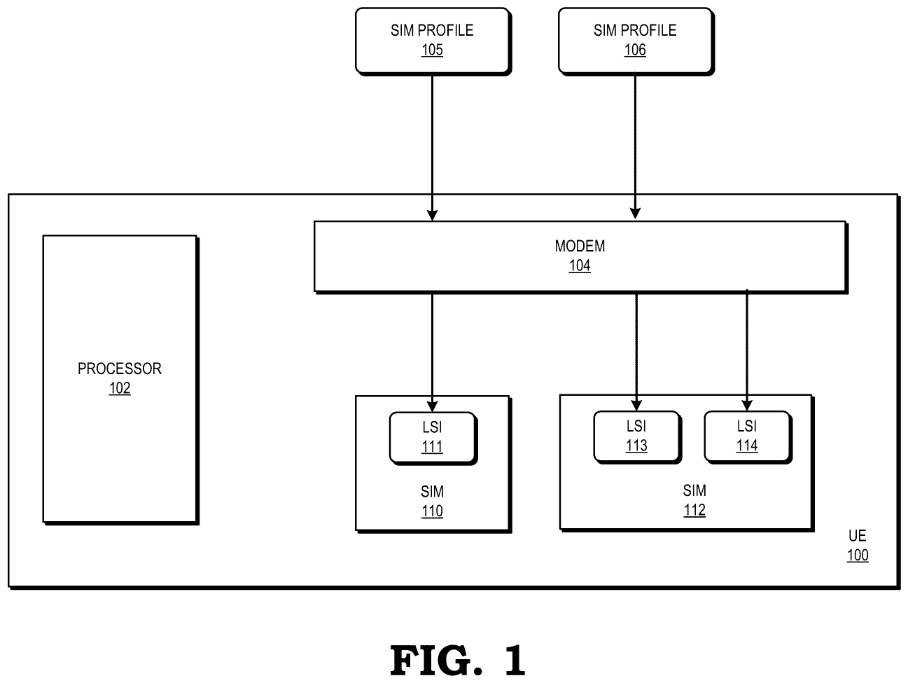

FIGS. 1-4 illustrate systems and techniques for concurrently downloading available SIM profiles at a UE in accordance with some embodiments. For example, in some embodiments the UE identifies a condition wherein one or more SIM profiles is available for download. The UE first identifies the number of available SIM profiles and, in response to identifying multiple available SIM profiles, concurrently downloads at least two of the SIM profiles to the UE. This enables the UE to more quickly use the available SIM profiles to connect to corresponding networks, thereby improving the user experience with the UE.

To illustrate, in some cases a UE moves from one geographic area, with one set of available networks, to a different geographic area, with a different set of available networks. Upon entering the new geographic area, the UE does not have the required SIM profiles to connect to the newly available networks. Accordingly, the UE is configured to request the necessary SIM profiles from the corresponding networks, and each network then downloads the corresponding SIM profiles to the UE. However, with a conventional UE, when multiple SIM profiles are available for download the UE downloads the different SIM profiles in serial fashion. That is, the UE downloads a first profile, followed by a second profile (once downloading of the first profile is complete), and so on until all the available SIM profiles have been downloaded to the UE. However, in at least some cases a user of the UE wishes to quickly employ a SIM profile that is placed later in the download sequence. In such cases, the user must wait a relatively long amount of time (e.g., thirty seconds or more) until the desired profile has been downloaded.

Using the techniques and systems described herein, a UE concurrently downloads multiple available SIM profiles. Thus, in the example above, rather than downloading each available SIM profile in a serial sequence, the UE downloads at least two of the available SIM profiles concurrently (e.g., in parallel, or overlapping in time). The UE thus reduces the overall time required to download all of the available profiles. This allows the user to employ a desired SIM profile to connect to a corresponding network more quickly, thus improving the user experience with the UE.

In some embodiments, the UE concurrently downloads the available profiles via multiple logical secure element (SE) interfaces (LSIs). For example, in some embodiments the UE is configured to support multiple LSIs that support communication with multiple logical SEs (LSEs) over the same physical interface. A SIM may support multiple LSEs on the same physical element, and the UE handles each LSE like a separate physical SE. Each LSE operates logically independently from the other LSEs, including having a different file system, applications, application identifiers, security status, runtime environment, and card application toolkit (CAT) sessions (such that several LSEs can run interleaved or in parallel on different LSIs). This allows the UE to employ SIMs (e.g., an electronic SIMs, referred to as an eSIMs) wherein the SIM is able to communicate with different LSEs via corresponding LSIs. This in turn allows a given SIM to concurrently download multiple SIM profiles via different LSIs.

FIG. 1 illustrates an example hardware configuration for a UE 100 in support of concurrent downloading of SIM profiles in accordance with some embodiments. For purposes of description, it is assumed that the UE 100 is any device that is capable of connecting to one or more cellular networks using a SIM. Thus, in different embodiments, the UE 100 is a smartphone, a computer (e.g., a desktop or laptop computer), a wearable device (e.g., a smartwatch), a game console, a vehicular entertainment or navigation unit, and the like.

In the depicted example, the UE 100 includes a central processing unit (CPU) or other general processor 102, a modem 104, and SIMs 110 and 112. In some embodiments, the UE 100 includes additional circuitry to support wireless network connections, such as a wireless local area network (WLAN) transceiver and modem, at least one WLAN antenna suitable for radio frequency (RF) signaling and signal processing in one or more frequency bands typically associated with WLAN connections, an RF transceiver, and at least one RF antenna suitable for RF signaling and signal processing in frequency bands associated with cellular radio access technologies (RATs). Further, it will be appreciated that the UE 100 can include a number of additional components omitted from FIG. 1 for ease of illustration, including, for example, one or more displays, one or more touchscreens, keypads, mice, touchpads, microphones, speakers, and other user input/output devices, one or more sensors, batteries or other power sources, graphical processing units (GPUs) or other coprocessors, and the like.

As a general operational overview, the general processor 102 executes executable instructions from a software stack that includes an operating system (OS) and one or more user software applications, and which further can include the protocol stacks executed by processors of the modem 104. The OS manages the general operation of the various hardware components of the UE 100 as well as supports the execution of the one or more user software applications, with the user software applications typically accessed from system memory (not shown) for execution by the general processor 102. During execution, one or more processes of the OS or the user software application (referred to generally as “local processes”) may seek to wirelessly communicate data with a network connected to the UE 100.

In the event that a local process is seeking to communicate data with a network, the general processor 102 can employ a cellular RAT connection, communicating data via the modem 104. For these connections the modem 104 can handle lower-level operations associated with the corresponding network protocol, such as some or all of the physical, data link, and network layers, while the OS and the user software application executing at the general processor 102 support the higher-level layers of the network protocol, such as the transport, session, presentation, and application layers.

To support connection to networks, the UE 100 employs the SIMs 110 and 112. In particular, the SIMs 110 and 112 provide the data and functionality for connection by the UE 100 to a corresponding network (or multiple networks). In some embodiments, one or more of the SIMs 110 and 112 are physical SIMs, and in some embodiments one or more of the SIMs 110 and 112 are electronic SIMs (eSIMs). For example, in some embodiments, the SIM 110 is a physical SIM, and the SIM 112 is an eSIM.

Each of the SIMs 110 and 112 is configured to support one or more LSIs. For example, in the depicted embodiment the SIM 110 supports an LSI 111 and the SIM 112 supports LSIs 113 and 114. Each of the LSIs 111, 113, and 114 provides an interface for software executing at the processor 102 to interact with a corresponding LSE (not shown). In some embodiments, one or both of the SIMs 110 and 112 support multiple LSEs on the same physical element, and the UE 100 handles each LSE like a separate physical SE. Thus, each LSE operates logically independently from the other LSEs, including having a different file system, applications, application identifiers, security status, runtime environment, and card application toolkit (CAT) sessions (such that several LSEs can run interleaved or in parallel on different LSIs). The processor 102 communicates with the different LSEs via the corresponding LSIs 111, 113, and 114. In some embodiments, each LSE is a secure element that is consistent with (or as set forth in) a Universal Mobile Telecommunications System (UTMS) specification, such as European Telecommunications Standards Institute (ETSI) Technical Standard (TS) 102 221 version 17.2.0 Release 17, and each of the LSIs 111, 113, and 114 is a secure interface that is consistent with (or as set forth in) the same specification.

For simplicity, the interactions between the processor 102 and the different sets of LSIs and their corresponding LSEs are described herein as interactions with the LSIs. Thus, for example, if the processor 102 sends a command or request to an LSE via the corresponding LSI, for simplicity this is referred to herein as requesting, or sending a command, to the LSI. As another example, if an LSI and corresponding LSE take action in response to a command (such as communicating with a network or downloading a profile), this is referred to herein for simplicity as the LSI taking the corresponding action.

In some embodiments the processor 102 interacts with the LSIs 111, 113, and 114, and the corresponding LSEs, using a set of commands as set forth in the corresponding specification. For example, in some embodiments the processor 102 can send commands to each of the LSIs 111, 113, and 114 to select an LSI, to reset a corresponding LSE, configure the LSI, and the like. The processor 102 also interacts with each LSE by sending commands, as specified by the corresponding card application toolkit (CAT), via the corresponding LSE. Via these different commands, software executing at the processor 102 is able to control the LSI 111, 113, and 114 to perform specified actions, including requesting one or more of the LSIs to download a SIM profile from a corresponding network to one of the SIMs 110 and 112, so that the UE 100 is able to connect with and communicate via the network. Furthermore, because the LSIs 111, 113, and 114 (and each corresponding LSE) are separate and independent logical entities, the UE 100 can download multiple profiles concurrently, thus reducing the total time required to download all available profiles.

For example, in some embodiments, the processor 102 is configured to identify when a new or different SIM profile is available for download via a corresponding network. In some embodiments, the processor 102 makes this identification based on user action, such as user scanning a quick-response (QR) code provided by a network operator or provider. In other embodiments, the processor 102 makes the identification in response to determining the UE 100 has entered a new geographic area (e.g., a new country), and employs a stored database of available networks and corresponding profiles to determine if new or different SIM profile information is available for download.

In response to determining that new or different SIM profile information is available, the processor 102 determines the number of SIM profiles available for download. In response to identifying a single available SIM profile, the processor 102 sends a command to the LSI 111 to download the available SIM profile. Responsive to the command, the LSI 111 (and corresponding LSE) sends a message to the network associated with the available profile, causing the profile (e.g., SIM profile 106) to be downloaded to the SIM 110. The processor 102 can then use the downloaded profile (via interactions with the SIM 110) to connect to the network.

In response to identifying multiple available SIM profiles, the processor 102 sends separate commands to different LSIs to download the multiple profiles concurrently. For example, in response to determining that both SIM profile 105 and SIM profile 106 are available for download, the processor 102 sends a message to the LSI 111 to download the SIM profile 105 and a message to the LSI 113 to download the SIM profile 106. Responsive to the messages, the LSIs 111 and 113 (together with the corresponding LSEs) send messages to the corresponding networks to download the SIM profiles 105 and 106, respectively. In at least some embodiments, at least a portion of each of the SIM profiles 105 and 106 are downloaded concurrently or in parallel, thus reducing the overall time required to download both of the SIM profiles 105 and 106. Once the SIM profiles 105 and 106 are downloaded, the processor 102 can use either profile to connect to a corresponding network based on, for example, a user selection of a particular network or SIM profile.

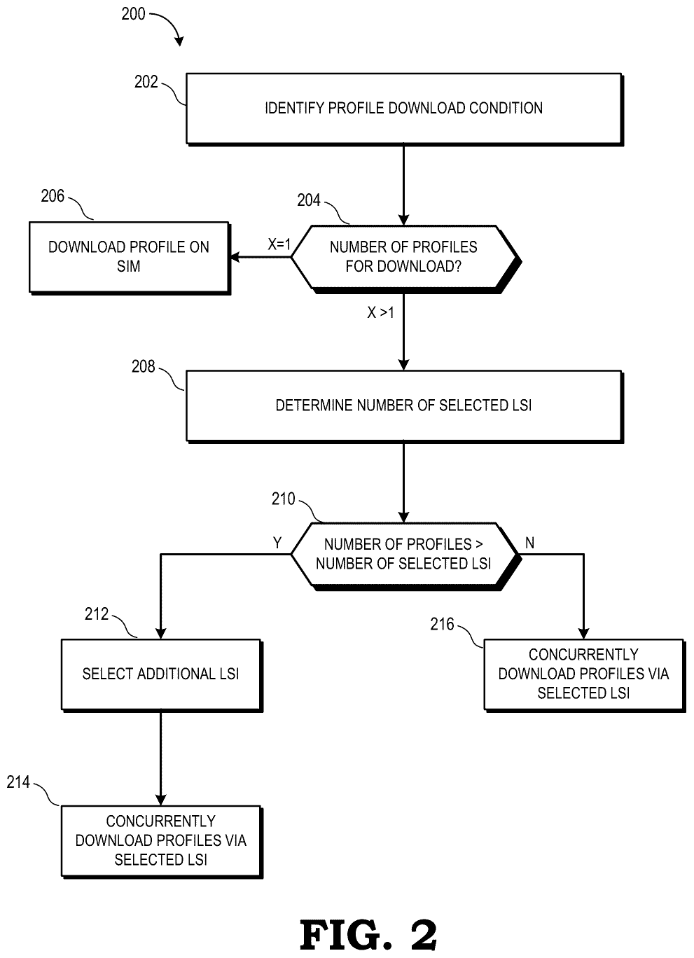

FIG. 2 illustrates a flow diagram of a method 200 of concurrently downloading SIM profiles to a UE in accordance with some embodiments. For purposes of description, the method 200 is described with respect to an example implementation at the UE 100 of FIG. 1, but it will be appreciated that in other embodiments the method 200 is implemented at a UE having a different configuration.

At block 202 the processor 102 identifies a profile download condition, indicating one or more SIM profiles (that are not currently stored at the UE 100) are available to download. In some embodiments, the profile download condition is indicated by a user action, such as the user scanning a QR code indicating the network associated with the SIM profile, the user selecting a network or SIM profile from a list of networks or SIM profiles displayed by the UE 100, and the like. In some embodiments, the profile download condition is indicated by a change in the operating conditions of the UE 100, such as the Global Positioning System (GPS), a network message, or other condition indicating that the UE 100 has entered a geographic area with one or more networks for which the UE 100 currently does not store a SIM profile.

In response to identifying the profile download condition, at block 204 the processor 102 determines the number of SIM profiles available for download. For example, in some embodiments the processor 102 requests the modem 104 transmit one or more network queries to identify the networks that are currently available for connection by the UE 100. The processor 102 then identifies for which of the identified networks the UE 100 currently does not store a SIM profile. The processor 102 indicates that a SIM profile is to be downloaded for each of the identified networks. If the processor 102 identifies a single profile for download, the method flow moves to block 206 and the processor 102 sends a command to the SIM 110 to download the profile (e.g., SIM profile 106). In response the SIM 110 sends, via the modem 104, a message to the corresponding network to download the SIM profile.

Returning to block 204, if the processor 102 determines that more than one SIM profile is available for download, the method flow moves to block 208 and the processor 102 sends messages to the SIMs 110 and 112 to determine the number of LSI that have currently been selected. At block 210, the processor 102 determines if the number of available SIM profiles exceeds the number of selected LSIs. If not, the method flow moves to block 216 and the processor 102 identifies the selected LSIs designated to download each SIM profile. The processor 102 sends messages to each identified LSI to download the corresponding SIM profile. In response to the messages, each identified LSI sends a message to a corresponding network to download its assigned SIM profile. The SIM card associated with the LSI stores the downloaded SIM profile, and the processor 102 can use any downloaded SIM profile to connect to a corresponding network. Furthermore, the LSI can download the SIM profiles concurrently, thereby allowing more SIM profiles to be downloaded in a given amount of time, and thus allowing the user to connect to any of the available networks more quickly.

Returning to block 210, if the processor 102 determines that the number of available profiles exceeds the number of selected LSI, the method proceeds to block 212 and the processor 102 sends messages to the SIMs 110 and 112 to select additional LSI. For example, if there are three SIM profiles available for download and the processor 102 determines that only the LSI 111 and LSI 113 are selected, the processor 102 sends a message to the SIM 112 to select the LSI 114. The method proceeds to block 214 and the processor 102 identifies the selected LSIs designated to download each SIM profile. The processor 102 sends messages to each identified LSI to download the corresponding SIM profile. In response to the messages, each identified LSI sends a message to a corresponding network to download its assigned SIM profile.

In some embodiments, the UE 100 does not support sufficient LSIs to concurrently download all available SIM profiles. Accordingly, the processor 102 first causes all available LSIs to be selected, and concurrently downloads a set of the available SIM profiles via the selected LSIs. Once an LSI becomes available (upon completing the download of a SIM profile), the processor 102 sends a message to the LSI to download another available SIM profile. The UE 100 thus sequentially downloads subsets of the available SIM profiles, wherein one or more of the subsets includes multiple SIM profiles that the UE 100 downloads concurrently.

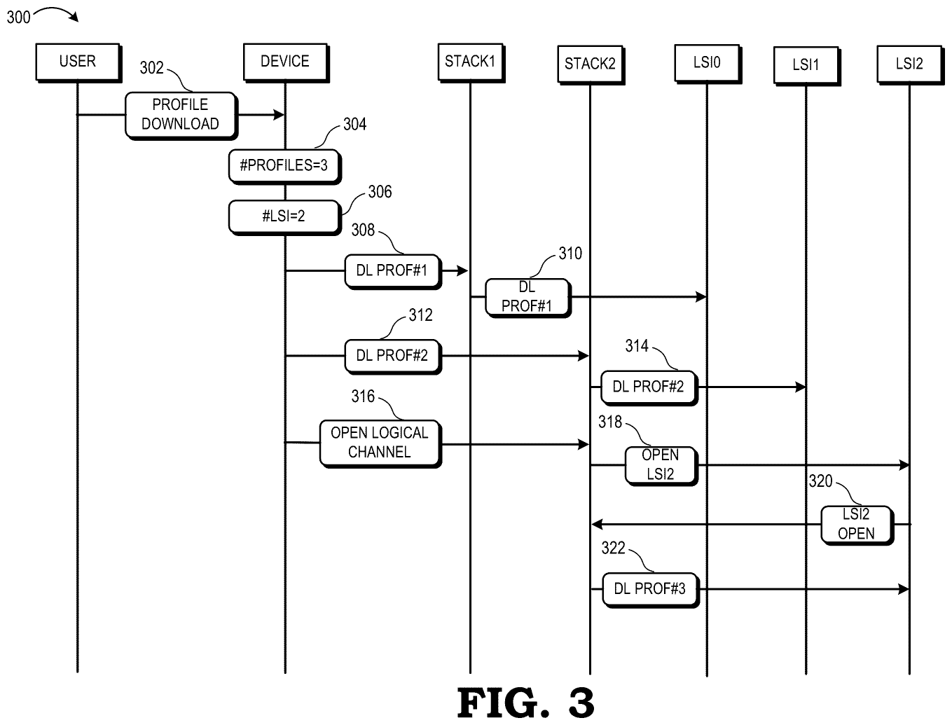

FIG. 3 illustrates a signal flow diagram 300 of a method of the UE 100 concurrently downloading SIM profiles in accordance with some embodiments. At block 302, a user performs an action, such as scanning a QR code, which identifies a plurality of SIM profiles are available for download. At block 304, in response to the user action the processor 102 identifies the number of profiles available for download. In some embodiments, the number of available profiles is indicated by the user action. For example, in some embodiments the scanned QR code indicates the number of available SIM profiles. In other embodiments the user scans a different QR code for each available SIM profile. For the purpose of the example of FIG. 3, the number of available SIM profiles is three.

At block 306, the processor 102 queries the SIMs 110 and 112 to identify the number of selected LSIs and determines that the number of selected LSIs is two. At block 308, the processor 102 sends a message to the SIM 110 to download an available SIM profile via the LSI 111 (and via the corresponding LSE). At block 310, the LSI 111 downloads the first SIM profile. At block 312, the processor 102 sends a message to the SIM 112 to download an available SIM profile via the LSI 113 (and via the corresponding LSE). At block 314, the LSI 113 downloads the second SIM profile.

At block 316, the processor 102 sends a message to the SIM 112 to select an additional LSI, thereby opening another logical channel to download the third SIM profile. In response, at block 318, the SIM 112 opens the LSI 114. At block 320, the LSI 114 sends a message to the SIM 112 indicating that LSI 114 is open and available. At block 310, the LSI 114 downloads the third SIM profile. It will be appreciated that the downloading of the three SIM profiles is shown at FIG. 3 in non-overlapping fashion for clarity of the figure. However, in at least some embodiments, blocks 310, 314, and 322 take place concurrently in time, such that the three SIM profiles are downloaded concurrently.

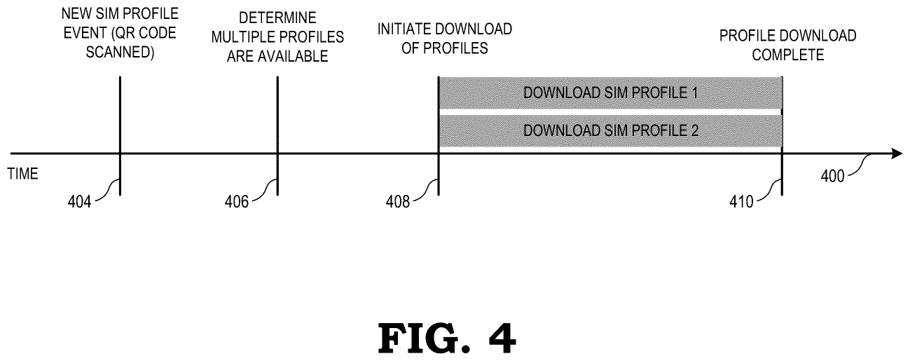

FIG. 4 illustrates a timeline 400 depicting a sequence of events at the UE 100 associated with downloading of SIM profiles in accordance with some embodiments. In the depicted example, at time 404 a new SIM profile event takes place, indicating that multiple SIM profiles are available to download at the UE 100. For example, at time 404 a user scans one or more QR codes indicating the availability of multiple SIM profiles for download. At time 406, the processor 102 determines that there are two SIM profiles available for download and sends commands to the SIMs 110 and 112 to download the two SIM profiles via LSIs 111 and 113, respectively. At time 408, the LSIs 111 and 113 initiate the downloading of the two SIM profiles and, at time 410, the downloading of the two SIM profiles is complete. Furthermore, as illustrated at FIG. 4, the downloading of the two SIM profiles occurs concurrently. In contrast, a conventional UE would download the two SIM profiles in sequential fashion, extending the time 410. Thus, using the techniques described herein, a UE concurrently downloads multiple SIM profiles, reducing the overall download time and improving the user experience with the UE.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
identifying, at a user equipment (UE) a first plurality of available subscriber identity module (SIM) profiles; and
in response to identifying the plurality of SIM profiles, concurrently downloading the first plurality of SIM profiles to the UE.

2. The method of claim 1, wherein concurrently downloading comprises concurrently downloading the first plurality of SIM profiles via corresponding ones of a plurality of logical secure element interfaces (LSIs).

3. The method of claim 2, further comprising:
opening a first LSI of the plurality of LSIs in response to identifying the plurality of SIM profiles.

4. The method of claim 3, wherein opening the first LSI comprises opening the first LSI in response to determining that a number of the available SIM profiles exceeds a number of open LSIs at the UE.

5. The method of claim 1, further comprising:
after downloading the first plurality of SIM profiles, concurrently downloading a second plurality of SIM profiles to the UE.

6. The method of claim 5, wherein downloading the second plurality of SIM profiles comprises downloading the second plurality of SIM profiles after the first plurality in response to determining a total number of available SIM profiles exceeds a number of LSIs at the UE.

7. The method of claim 6, wherein downloading the first plurality of SIM profiles comprises downloading a first SIM profile via a first LSI and a second SIM profile via a second LSI.

8. The method of claim 7, wherein downloading the second plurality of SIM profiles comprises downloading a third SIM profile via the first LSI and a fourth SIM profile via the second LSI.

9. The method of claim 8, wherein the first LSI is assigned to a first protocol stack of the UE and the second LSI is assigned to a second protocol stack of the UE.

10. The method of claim 1, wherein the plurality of SIM profiles are electronic SIM (eSIM) profiles.
